(19) United States
(12) Patent Application Publication
(10) Pub. No.: US 2014/0086789 A1
(43) Pub. Date: Mar. 27, 2014

(54) ALUMINUM ALLOY FOR VEHICLE AND WHEEL FOR MOTORCYCLE

(71) Applicant: Honda Motor Co., Ltd., Tokyo (JP)

(72) Inventors: Masaki Agata, Wako-shi (JP); Kyo Takahashi, Wako-shi (JP); Toshimitsu Suzuki, Wako-shi (JP)

(73) Assignee: HONDA MOTOR CO., LTD., Tokyo (JP)

(21) Appl. No.: 14/033,769

(22) Filed: Sep. 23, 2013

(30) Foreign Application Priority Data
Sep. 27, 2012 (JP) 2012-213967

(51) Int. Cl. C22C 21/02; B60B 21/00

(52) U.S. Cl. CPC C22C 21/02; B60B 21/00
USPC 420/532; 164/128; 164/47

(57) ABSTRACT

An aluminum alloy for a vehicle has the composition including, by weight %, 0.5% or less of Fe, 0.2% or less of Mn, Si, and Cu with the balance being Al and unavoidable impurities, wherein dendrite arm spacing is 45 μm or less, and a size of an intermetallic compound is 150 μm or less.

### BACKGROUND OF THE INVENTION

1. Field of the Invention

The present invention relates to an aluminum alloy for a vehicle and a wheel for a motorcycle that is manufactured using the aluminum alloy.

2. Description of Related Art

As a material for a part that is required to have a high degree of strength and toughness, such as a wheel for an automobile or a motorcycle, conventionally, there has been proposed an aluminum alloy to which some elements are added to new ingot aluminum (also referred to as an aluminum primary alloy (see JP-A-2003-27169, for example)).

When new ingot aluminum such as an aluminum alloy described in JP-A-2003-27169 is used, in view of facts that new ingot aluminum is expensive and that the manufacture of new ingot aluminum emits a large quantity of CO₂ gas and hence, there has been a demand for the manufacture of an aluminum alloy material that uses, as a raw material, a reproduced ingot aluminum material (also referred to as an aluminum secondary alloy), which is an aluminum recycled material. However, when the reproduced ingot aluminum material is used, the aluminum alloy material contains a material such as Fe, which lowers toughness (elongation). Accordingly, it is difficult to use the reproduced ingot aluminum material in a vehicle part that is required to have toughness.

### SUMMARY OF THE INVENTION

The present invention has been made in view of the above-mentioned circumstances, and it is an object of the invention to provide an aluminum alloy for a vehicle and a wheel for a motorcycle that can ensure toughness suitable for a vehicle part even when an aluminum material containing an impurity such as Fe is used.

To achieve the above-mentioned object, the invention is directed to an aluminum alloy for a vehicle having the composition comprises, by weight %, 0.5% or less of Fe, 0.2% or less of Mn, Si, and Cu with the balance being Al and unavoidable impurities, wherein dendrite arm spacing (DAS) is 45 μm or less, and a size of an intermetallic compound is 150 μm or less.

According to the invention, an aluminum alloy for a vehicle which has toughness suitable for a vehicle part can be acquired using an aluminum raw material containing Fe, Mn, Cu or the like as impurities such as a reproduced ingot aluminum material.

In the above-mentioned aluminum alloy for a vehicle, it is preferable that the dendrite arm spacing is 40 μm or less and the size of the intermetallic compound is 100 μm or less.

In this case, it is possible to acquire an aluminum alloy for a vehicle whose toughness is even more excellent.

In the above-mentioned aluminum alloy for a vehicle, it is preferable that the dendrite arm spacing is 35 μm or less and the size of the intermetallic compound is 70 μm or less. In this case, it is possible to acquire an aluminum alloy for a vehicle whose toughness is even more excellent.

In the above-mentioned aluminum alloy for a vehicle, it is preferable that the dendrite arm spacing is 25 μm or less and the size of the intermetallic compound is 30 μm or less. In this case, it is possible to acquire an aluminum alloy for a vehicle whose toughness is even more excellent.

A wheel for a motorcycle according to the invention is formed using the above-mentioned aluminum alloy for a vehicle. According to the invention, it is possible to provide a wheel for a motorcycle that has favorable toughness.

In the above-mentioned wheel for a motorcycle, it is preferable that a thickness of a rim portion is set to 20 mm or less. According to the invention, the rim portion is speedily cooled at the time of casting and hence, crystallization time of primary crystals during cooling can be shortened whereby dendrite arm spacing in the rim portion can be made smaller. Further, the growth of a needle-shaped intermetallic compound in crystallization time of eutectic crystals can be suppressed. Accordingly, it is possible to impart a characteristic more suitable for a vehicle part to the aluminum alloy for manufacturing a wheel for a motorcycle so that it is possible to provide a wheel for a motorcycle having excellent toughness.

It is preferable that the above-mentioned wheel for a motorcycle is manufactured by gravity die casting using a die that includes an upper die, a lower die and a slide die having a rim portion, and forms a cooling liquid flow passage for accelerating a cooling rate in a portion of at least any one of the upper die, the lower die or the slide die where the rim portion is formed. In this case, with the use of the die where the cooling liquid flow passage is formed in any one of the upper die, the lower die or the slide die, the rim portion can be speedily cooled at the time of casting. Accordingly, dendrite arm spacing in the rim portion of the wheel for a motorcycle can be made smaller, and the growth of a needle-shaped intermetallic compound can be suppressed. Accordingly, it is possible to provide the wheel for a motorcycle having excellent toughness and can be manufactured at a low cost.

The above-mentioned wheel for a motorcycle may be manufactured by low pressure die casting using the above-mentioned die. It is preferable that the above-mentioned wheel for a motorcycle is manufactured by gravity die casting using a die that includes an upper die, a lower die and a slide die having a rim portion, and has a molding surface thereof for forming the rim portion formed on any one of the upper die, the lower die and the slide die using a beryllium copper alloy. In this case, with the use of the die where the beryllium copper alloy is arranged on any one of the upper die, the lower die or the slide die, heat can be speedily radiated from the rim portion through the molding surface where the rim portion is formed at the time of casting so that a cooling time can be shortened. Accordingly, dendrite arm spacing in the rim portion of the wheel for a motorcycle can be made smaller, and the growth of a needle-shaped intermetallic compound can be suppressed. Accordingly, it is possible to provide the wheel for a motorcycle that has excellent toughness and can be manufactured at a low cost.

According to the invention, an aluminum alloy for a vehicle that has toughness suitable for a vehicle part can be acquired using an aluminum raw material containing Fe, Mn, Cu or the like as impurities such as a reproduced ingot aluminum material and hence, it is possible to provide a wheel for a motorcycle having favorable toughness by using the aluminum alloy for a vehicle.

Further, the rim portion is speedily cooled at the time of casting and hence, crystallization time of primary crystals during cooling can be shortened whereby dendrite arm spacing in the rim portion can be made smaller whereby it is possible to suppress the growth of a needle-shaped intermetallic compound after crystallization of the primary crystals. Accordingly, it is possible to impart a characteristic more suitable for a vehicle part to the aluminum alloy for manufacturing a wheel for a motorcycle so that it is possible to provide a wheel for a motorcycle that has excellent toughness.

Further, with the use of the die where the cooling liquid flow passage is formed in any one of the upper die, the lower die or the slide die, the rim portion can be speedily cooled at the time of casting. Accordingly, dendrite arm spacing in the rim portion of the wheel for a motorcycle can be made smaller, and the growth of a needle-shaped intermetallic compound can be suppressed and hence, it is possible to provide the wheel for a motorcycle that has excellent toughness and can be manufactured at a low cost.

Further, with the use of the die where the beryllium copper alloy is arranged on a molding surface of at least any one of the upper die, the lower die or the slide die, heat can be speedily radiated from the rim portion at the time of casting so that a cooling time can be shortened. Accordingly, dendrite arm spacing in the rim portion of the wheel for a motorcycle can be made smaller, and the growth of a needle-shaped intermetallic compound can be suppressed and hence, it is possible to provide the wheel for a motorcycle that has excellent toughness and can be manufactured at a low cost.

### BRIEF DESCRIPTION OF THE DRAWINGS

FIG. 1A and FIG. 1B are views showing the constitution of a wheel for a motorcycle according to an embodiment of the invention, wherein FIG. 1A is a plan view and FIG. 1B is a cross-sectional view.

FIG. 2 is a cross-sectional view showing one example of a die used in the manufacture of the wheel for a motorcycle by casting.

FIG. 3 is a cross-sectional view showing another example of the die used in the manufacture of the wheel for a motorcycle by casting.

FIG. 4A to FIG. 4C are views showing conditions of sampling a specimen used in the measurement of toughness of a wheel for a motorcycle, wherein FIG. 4A is a perspective view, FIG. 4B is a front view, and FIG. 4C is a side view.

FIG. 5A and FIG. 5B are charts showing a characteristic of an aluminum alloy for a vehicle, wherein FIG. 5A shows an example of correlation between dendrite arm spacing and toughness, and FIG. 5B shows an example of correlation between a size of an intermetallic compound and toughness.

FIG. 6A and FIG. 6B are charts showing a characteristic of an aluminum alloy for a vehicle, wherein FIG. 6A shows an example of correlation between the content of Fe and a size of an intermetallic compound, and FIG. 6B shows an example of correlation between the content of Fe and toughness.

FIG. 7A and FIG. 7B are charts showing a characteristic of an aluminum alloy for a vehicle, wherein FIG. 7A shows an example of correlation between the content of Mn and a size of an intermetallic compound, and FIG. 7B shows an example of correlation between the content of Mn and toughness.

FIG. 8 is an optical microscope photograph of an aluminum alloy for a vehicle according to an embodiment.

FIG. 9 is an optical microscope photograph of an aluminum alloy according to a comparison example.

### DETAILED DESCRIPTION OF THE PREFERRED EMBODIMENTS

Hereinafter, embodiments of the invention are explained in conjunction with drawings.

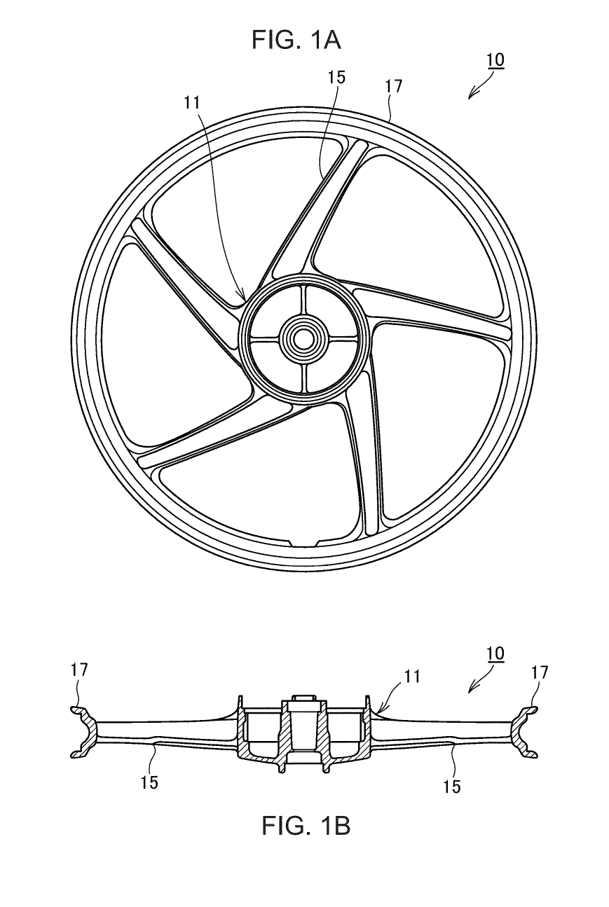

FIG. 1A and FIG. 1B are views showing the constitution of a wheel for a motorcycle 10 according to an embodiment to which the invention is applied, wherein FIG. 1A is a plan view, and FIG. 1B is a cross-sectional view.

The wheel for a motorcycle 10 shown in FIG. 1 is formed by casting as an integral body that is constituted of a hub 11, a plurality of spokes 15 extending radially from the hub 11, and a rim 17 on which a tire (not shown) is mounted.

As shown in FIG. 1B, the rim 17 is designed to have a small wall thickness, and it is preferable to set a thickness of the rim 17 to 20 mm or less.

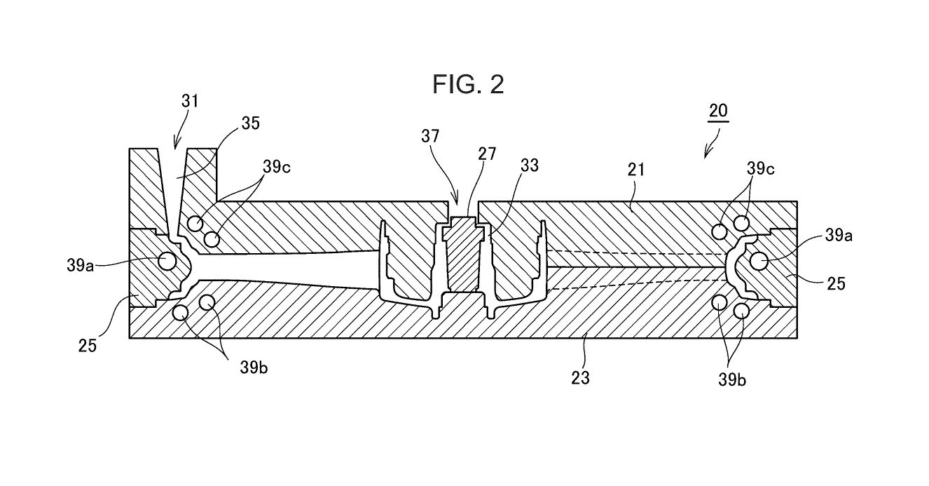

FIG. 2 is a view showing one example of a die for casting that is used in the manufacture of the wheel for a motorcycle 10 shown in FIG. 1. FIG. 2 shows a cross section of a die for casting 20 taken along a plane including an axis corresponding to a center axis (rotational axis) of the wheel for a motorcycle 10 such that a cavity corresponding to one of spokes 15 is cut.

The die for casting 20 shown in FIG. 2 is a die for manufacturing the wheel for a motorcycle 10 by gravity die casting (GDC), and is constituted of steel-made partial dies including an upper die 21, a lower die 23 and a slide die 25. The slide die 25 is fitted into the upper die 21 and the lower die 23 from a side and is used for forming the rim 17 of the wheel for a motorcycle 10. A core 27 that is used for forming a hollow portion of the hub 11 is arranged in a cavity, which is formed in the die for casting 20 and corresponds to the axial center of the wheel for a motorcycle 10.

A pouring port 31 from which molten aluminum is poured is formed in the upper die 21. The pouring port 31 is communicated with the cavities at positions where end portions of the rims 17 are formed, and molten metal poured from the pouring port 31 passes the cavities and reaches a discharge port 37 formed at the center of the upper die 21.

A cooling liquid flow passage 39a through which a cooling liquid such as water passes is formed in the slide die 25. The cooling liquid flow passage 39a is formed at a position that faces a peripheral surface of the rim 17. The cooling liquid is made to circulate in the cooling liquid flow passage 39a from the outside of the die for casting 20, and this cooling liquid can be discharged to the outside. FIG. 2 shows the cooling liquid flow passage 39a in cross section, wherein the cooling liquid flow passage 39a is preferably arranged such that the cooling liquid flow passage 39a surrounds the approximately whole outer periphery of the rim 17.

Cooling liquid flow passages 39b are formed in the lower die 23 at positions that face the cavity for forming the rim 17. Cooling liquid flow passages 39c are formed in the upper die 21 at positions that face the cavity for forming the rim 17. Although cross sections of the cooling liquid flow passages 39a to 39c are shown in FIG. 2, these cooling liquid flow passages 39a to 39c are arranged so as to draw an approximately arc shape along the circumferential direction of the rim 17. Accordingly, by circulating the cooling liquid in these cooling liquid flow passages 39a to 39c, the rim 17 can be substantially uniformly cooled at a desired cooling rate.

FIG. 2 exemplifies the constitution of the die for casting 20 where the cooling liquid flow passages 39a to 39c are formed in all dies consisting of the upper die 21, the lower die 23 and the slide die 25. However, provided that at least any one of the cooling liquid flow passages 39a to 39c is formed, the rim 17 can be cooled speedily compared to a case where none of these cooling liquid flow passages 39a to 39c is formed in the die for casting 20. Accordingly, even when only a portion of the cooling liquid flow passage 39a, 39b, 39c is formed in the die for casting 20, such a constitution can acquire the advantageous effect of the invention. For example, the cooling liquid flow passage may be constituted of only the cooling liquid flow passage 39a formed in the slide die 25, the cooling liquid flow passage may be constituted of the cooling liquid flow passage 39c formed in the upper die 21 and the cooling liquid flow passage 39b formed in the lower die 23, or the cooling liquid flow passage may be constituted of all cooling liquid flow passages 39a to 39c formed in the die for casting 20.

In the manufacture of the wheel for a motorcycle 10 by casting using the die for casting 20, after the cavity is filled with molten metal, a cooling liquid is made to flow into the cooling liquid flow passages 39a to 39c so as to cool the slide die 25. Accordingly, an aluminum alloy for forming the rim 17 can be speedily cooled. Although a peripheral surface of the rim 17 is particularly cooled in this step, as described previously, a wall thickness of the rim 17 is small, that is, 20 mm or less and hence, the whole rim 17 can be cooled at a high speed compared to other portions (the hub 11, the spokes 15 and the like) of the wheel for a motorcycle 10.

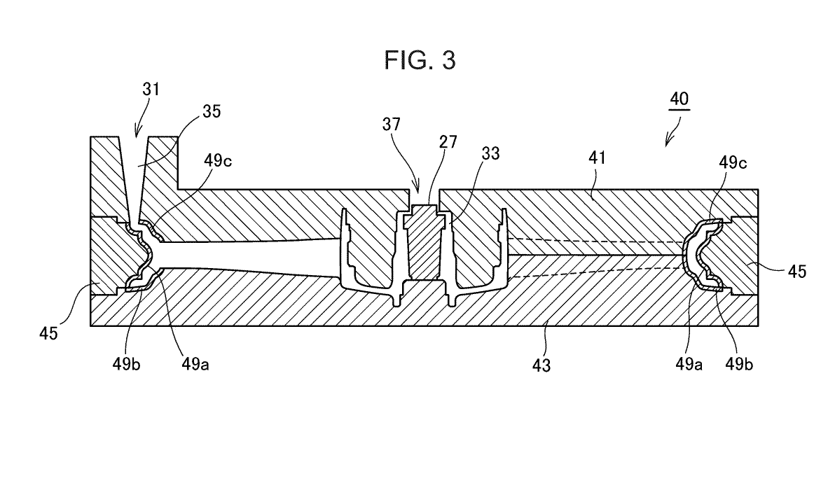

FIG. 3 is a view showing another example of the die for casting used in the manufacture of the wheel for a motorcycle 10. In the same manner as FIG. 2, FIG. 3 shows a cross section of a die for casting 40 taken along a plane including an axis corresponding to a center axis (rotational axis) of the wheel for a motorcycle 10 such that a cavity corresponding to one of spokes 15 is cut.

In the same manner as the die for casting 20 (FIG. 2), the die for casting 40 is a die for manufacturing the wheel for a motorcycle 10 by gravity die casting. The die for casting 40 has the constitution where the upper die 21 is substituted with an upper die 41, the lower die 23 is substituted with a lower die 43 and the slide die 25 is substituted with a slide die 45. Other constitutions of the die for casting 40 are common with other constitutions of the die for casting 20.

The upper die 41, the lower die 43 and the slide die 45 that constitute the die for casting 40 are made of the same steel material used for manufacturing the upper die 21, the lower die 23 and the slide die 25. The upper die 41, the lower die 43 and the slide die 45 are combined with the same core 27 thus forming a cavity having the same shape as the cavity formed in the die for casting 20. None of cooling liquid flow passages 39a to 39c is formed in the upper die 41, the lower die 43 and the slide die 45, but a beryllium copper alloy is arranged on portions of the upper die 41, the lower die 43 and the slide die 45.

A portion of the slide die 45 including a molding surface 49a used for forming a peripheral surface of a rim 17 is made of a beryllium copper alloy. The composition of the beryllium copper alloy may have the generally-known composition comprising 0.5 to 3.0% of beryllium and copper as the balance. The beryllium copper alloy may be a highly conductive beryllium copper alloy which contains nickel and cobalt in addition to beryllium. The beryllium copper alloy has high heat conductivity compared to heat conductivity of a steel material used for forming the upper die 41, the lower die 43 and the slide die 45. Accordingly, a portion of molten metal poured into the die for casting 40, which is brought into contact with the molding surface 49a, is cooled speedily compared to other portions.

A portion of the lower die 43 including a molding surface 49b used for forming the rim 17 is also made of a beryllium copper alloy, and a portion of the upper die 21 including a molding surface 49c used for forming the rim 17 is also made of a beryllium copper alloy. These molding surfaces 49a to 49c draw an approximately arc shape along the circumferential direction of the rim 17 and hence, the heat can be radiated speedily from the whole periphery of the rim 17.

FIG. 3 exemplifies the constitution of the die for casting 40 where a beryllium copper alloy is arranged on molding surfaces 49a to 49c used for forming the rim 17 by molding in all dies consisting of the upper die 41, the lower die 43 and the slide die 45. However, provided that at least any one of the molding surfaces 49a, 49b, 49c is formed using a beryllium copper alloy, the rim 17 can be cooled speedily compared to a case where the rim 17 is formed by casting using a die that does not use a beryllium copper alloy.

Accordingly, in the constitution where a beryllium copper alloy is arranged on the die for casting 40, even when a beryllium copper alloy is arranged only on a portion of any one of the upper die 41, the lower die 43 or the slide die 45, it is possible to acquire the advantageous effect of the invention. For example, a beryllium copper alloy may be arranged only on the upper die 41 and the lower die 43, or a beryllium copper alloy may be arranged only on the slide die 45. In this manner, in the manufacture of the wheel for a motorcycle 10 by casting using the die for casting 20 or the die for casting 40, the rim 17 can be cooled at a higher speed.

An aluminum alloy for a vehicle which is used for forming a vehicle part such as the wheel for a motorcycle 10 is required to possess an elongation characteristic (toughness). In general, it is known that the toughness of the aluminum alloy is lowered along with the increase of the content of Fe which is contained in an aluminum material as an impurity. The inventors of the invention have found that the lowering of the toughness is influenced by an intermetallic compound that is formed between primary-crystal α-Al crystals. The needle-shaped intermetallic compound is an Al—Fe—Si eutectic crystal or an Al—Fe—Mn—Si eutectic crystal contained in eutectic crystals which solidify after primary crystallization, and these eutectic crystals are formed at a temperature higher than a temperature at which α—Si eutectic crystals are formed. These intermetallic compounds take various shapes depending on the content of Fe and the content of Mn in the aluminum alloy, and are formed into a needle shape or a lump shape. The inventors of the invention have found that the toughness of a casting product is lowered along with the increase of a size of an intermetallic compound containing Fe. Here, the size of the intermetallic compound means a maximum length in one certain direction, and means neither an area of the intermetallic compound nor a volume of the intermetallic compound. Accordingly, the size of the needle-shaped intermetallic compound is liable to be increased. It is considered that the larger the size of the intermetallic compound, the more the intermetallic compound induces or promotes the rupture of a cast product when an external force is applied to the cast product.

It is effective to accelerate a cooling rate for suppressing the size of a crystal. However, the mere acceleration of a cooling rate gives rise to a possibility that the running of molten metal in the die for casting 20, 40 becomes defective or insufficient. Particularly, molten metal is not poured into a die under pressure in the gravity die casting and hence, there is a possibility that a temperature of molten metal is lowered while flowing in the die thus influencing the running property of molten metal.

The inventors of the invention have found that it is effective to shorten a period where the intermetallic compound grows for decreasing a size of the intermetallic compound containing Fe. That is, the growth of a needle-shaped intermetallic compound can be suppressed by cooling molten metal during the above-mentioned period. Molten metal has already circulated in the cavity in the period where the intermetallic compound grows and hence, even when a cooling rate is accelerated, the running property of molten metal is hardly influenced.

In view of the above, with the use of the die for casting 20 where the cooling liquid flow passages 39a to 39c are formed in at least any one of the upper die 21, the lower die 23 or the slide die 25, the size of the intermetallic compound can be effectively suppressed. In this case, a flow rate of a cooling liquid which circulates in the cooling liquid flow passages 39a to 39c may be adjusted such that a cooling rate is accelerated at timing that the growth of the intermetallic compound starts. With the use of the die for casting 20, particularly, the rim 17 of the wheel for a motorcycle 10 is surely and speedily cooled by a cooling liquid. Accordingly, the toughness of the rim 17 particularly can be increased. It is needless to say that the enhancement of the toughness of the whole wheel for a motorcycle 10 can be expected due to an effect of the cooling liquid.

Further, with the use of the die for casting 40, the radiation of heat from the molding surfaces 49a to 49c made of a beryllium copper alloy is promoted. Accordingly, in the same manner as the case where the die for casting 20 is used, the period where an intermetallic compound grows can be effectively shortened. The die for casting 40 adopts the constitution where a beryllium copper alloy is arranged on the molding surface 43 that constitutes the peripheral surface of the rim 17. Accordingly, while the rim 17 can be effectively cooled, a cooling rate of the whole cavity is not largely accelerated so that the defective running of molten metal can be prevented.

The inventors of the invention also have found that when dendrite arm spacing (DAS) between primary-crystal α-Al crystals is small, a size of an intermetallic compound becomes small. To decrease the dendrite arm spacing, it is effective to shorten a period where primary-crystal α-Al crystals grow. On the other hand, there exists a concern that the running property of molten metal is influenced by the cooling of molten metal.

In view of the above, the inventors of the invention have measured a dendrite arm spacing and a size of an intermetallic compound of aluminum alloys, with varying compositions of the aluminum alloys used for casting, and have made the following finding with respect to the aluminum alloys which possess the favorable toughness when used for manufacturing vehicle parts.

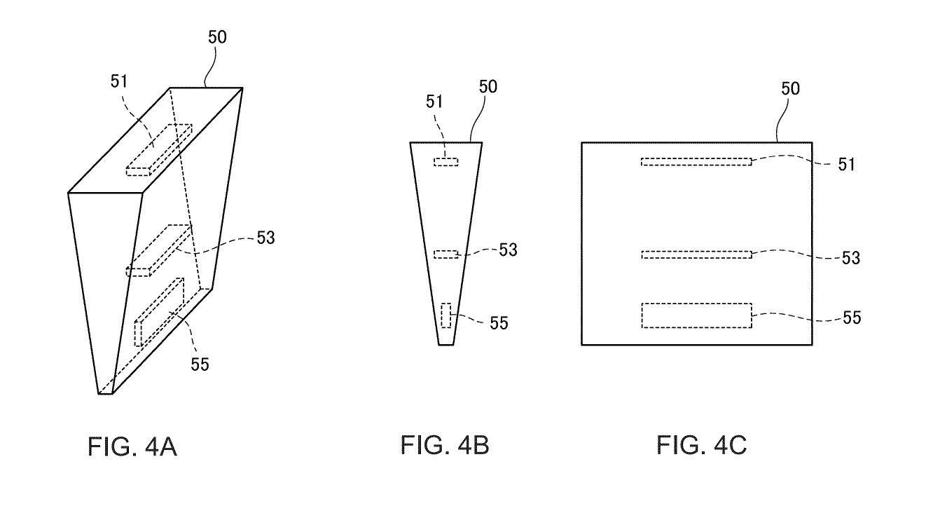

FIG. 4A to FIG. 4C are views showing conditions of sampling a specimen used in the measurement of toughness of the wheel for a motorcycle 10, wherein FIG. 4A is a perspective view, FIG. 4B is a front view, and FIG. 4C is a side view.

In measuring the toughness of the aluminum alloy explained hereinafter, the wheel for a motorcycle 10 is manufactured by casting using the die for casting 20, specimens 51, 53, 55 having a rectangular parallelepiped shape are cut out from a sprue 50 of a cast product that is formed in a space 35 defined in the pouring port 31, and mechanical characteristics of these specimens are measured using a tensile strength tester. Each measured value described later is an average of measured values with respect to the plurality of specimens 51, 53, 55 that are cut out from one wheel for a motorcycle 10. Further, with respect to the respective specimens 51, 53, 55, dendrite arm spacing and a size of the intermetallic compound are measured based on an optical microscope (metallurgical microscope) photograph.

As a reproduced ingot aluminum material, with respect to non-ferrous metal scraps, there have been known a malleable-material-based scrap that mainly uses aluminum sashes (extruded material) or a malleable aluminum material as a main raw material, and cast-material-based scraps which contain cast-material-based scraps and materials crushed by a shredder. To take a reproduced ingot aluminum material, which is popularly commercially available, as an example, as a reproduced ingot aluminum material which is manufactured using malleable-material-based scraps, for example, there has been known a material which comprises 1.0% of Si, 0.3 to 0.5% of Mg, and 0.3% or less of Mn, and also comprises 0.2 to 1.0% of Cu, 0.4 to 1.5% of Zn, and 0.6 to 1.1% of Fe as impurities. Further, as a reproduced ingot aluminum material that is manufactured using cast-material-based scraps, for example, there has been known a material which comprises 6.0 to 7.0% of Si, 0.2 to 0.4% of Mg, and 0.2% or less of Mn, and also comprises 1.5 to 2.5% of Cu, 1.2 to 1.5% of Zn, and 0.8 to 1.1% of Fe as impurities.

When the reproduced ingot aluminum material manufactured using malleable-material-based scraps and the reproduced ingot aluminum material manufactured using cast-material-based scraps are used for an aluminum alloy for a vehicle by suitably selecting one of these scraps or mixing these scraps, the composition of the aluminum alloy for a vehicle comprises 1.0% or more of Si, 0.2% or more of Mg, and 0.3% or less of Mn, and also comprises 0.2% or more of Cu, 0.4% of Zn, and 0.6% or more of Fe as impurities. Although it may be possible to use these reproduced ingot aluminum materials and a new ingot aluminum material in mixture, Cu, Zn and Fe are mixed into the manufactured material as impurities also in this case.

In view of the above, the inventors of the invention have found that an aluminum alloy for a vehicle having the following composition exhibits the favorable toughness when a vehicle part is formed by casting using the aluminum alloy for a vehicle. That is, the aluminum alloy for a vehicle has the composition comprising, by weight %, 0.5% or less of Fe, 0.2% or less of Mn, Si, and Cu with the balance being Al and unavoidable impurities, wherein dendrite arm spacing is 45 μm or less, and a size of an intermetallic compound is 150 μm or less. Such an aluminum alloy for a vehicle can be manufactured using an aluminum raw material containing impurities such as Fe and Cu. Accordingly, an aluminum alloy for a vehicle which has toughness suitable for a vehicle part can be acquired by making use of a reproduced ingot aluminum material or the like.

Si has an effect of increasing fluidity of molten metal at the time of manufacturing an aluminum alloy by casting. Fluidity of molten metal can be improved by setting the content of Si to 5.0% or more by weight %, and toughness (elongation) of a cast product can be ensured by setting the content of Si to 9.0% or less by weight %. Accordingly, it is preferable to set the content of Si in the aluminum alloy for a vehicle according to this embodiment to 5.0% or more and 9.0% or less.

Fe lowers the toughness of a cast product made of an Al—Si-based alloy. When the content of Fe is large, a large amount of Al—Si—Fe-based intermetallic compound having a needle shape is formed thus lowering the toughness of the cast product.

When Mn is added to the Al—Si-based alloy containing Fe, a lump-shaped Al—Si—Fe—Mn-based intermetallic compound, which does not adversely influence the toughness is formed, so that Mn possesses an effect of suppressing the formation of the above-mentioned Al—Si—Fe-based intermetallic compound having a needle shape. On the other hand, when the content of Mn is large, the toughness of a cast product is lowered. Accordingly, the content of Mn is preferably set to 0.2% or less.

Cu is considered as an impurity which impairs corrosion resistance of a cast product and lowers the toughness of the cast product. Accordingly, the content of Cu is preferably set to 0.4% or less. Zn is considered as an impurity which impairs corrosion resistance of a cast product.

Although Mg possesses an effect of increasing a tensile strength and a proof stress of a cast product, the toughness of the cast product is lowered along with the increase of the content of Mg.

By setting dendrite arm spacing to 40 μm or less and a size of an intermetallic compound to 100 μm or less, this kind of aluminum alloy for a vehicle can acquire the toughness suitable for a part of the vehicle more reliably. Accordingly, it is preferable to set dendrite arm spacing and the size of the intermetallic compound as described above.

Further, by setting the dendrite arm spacing to 35 μm or less and the size of the intermetallic compound to 70 μm or less, this kind of aluminum alloy for a vehicle can acquire the toughness suitable for a part of the vehicle more reliably. Accordingly, it is more preferable to set dendrite arm spacing and the size of the intermetallic compound as described above.

Still further, by setting the dendrite arm spacing to 25 μm or less and the size of the intermetallic compound to 30 μm or less, an aluminum alloy for a vehicle that possesses the more excellent toughness can be acquired. Accordingly, it is further more preferable to set dendrite arm spacing and the size of the intermetallic compound as described above.

These wheels for a motorcycle 10 that are formed using an aluminum alloy for a vehicle can be manufactured using a reproduced ingot aluminum material or the like as a raw material and possess the favorable toughness so that these wheels for a motorcycle 10 can be suitably used as wheels for a motorcycle.

Further, with respect to the wheel for a motorcycle 10, it is preferable that a thickness of the rim 17 is set to 20 mm or less. In this case, the rim 17 is speedily cooled at the time of casting and hence, a crystallization time of primary crystals during cooling can be shortened whereby dendrite arm spacing in the rim can be made smaller. Further, the growth of a needle-shaped intermetallic compound in a crystallization time of eutectic crystals can be suppressed so that the wheel for a motorcycle 10 can have more excellent toughness.

A method for manufacturing the wheel for a motorcycle 10 is not limited to the above-mentioned GDC, and the wheel for a motorcycle 10 may be manufactured by low pressure die casting (LPDC) using the die for casting 20, 40. Also in this case, by using the above-mentioned aluminum alloy for a vehicle, it is possible to acquire the wheel for a motorcycle 10 that can be manufactured using a reproduced ingot aluminum material or the like as a material and has favorable toughness.

Further, the aluminum alloy for a vehicle according to the invention is not limited to the wheels, but is also suitably used for suspension parts of a vehicle. For example, the suspension part having favorable toughness can be obtained by manufacturing a swing arm, a bracket (bridge) which holds a front fork and the like using the above-mentioned aluminum alloy for a vehicle.

Although examples of the invention are explained in detail hereinafter, the invention should not be construed in a limiting manner based on the description of the examples.

In the following examples, the casting and the evaluation are performed with respect to examples 1 to 11 to which the invention is applied and comparison examples 1 to 5, which are controls.

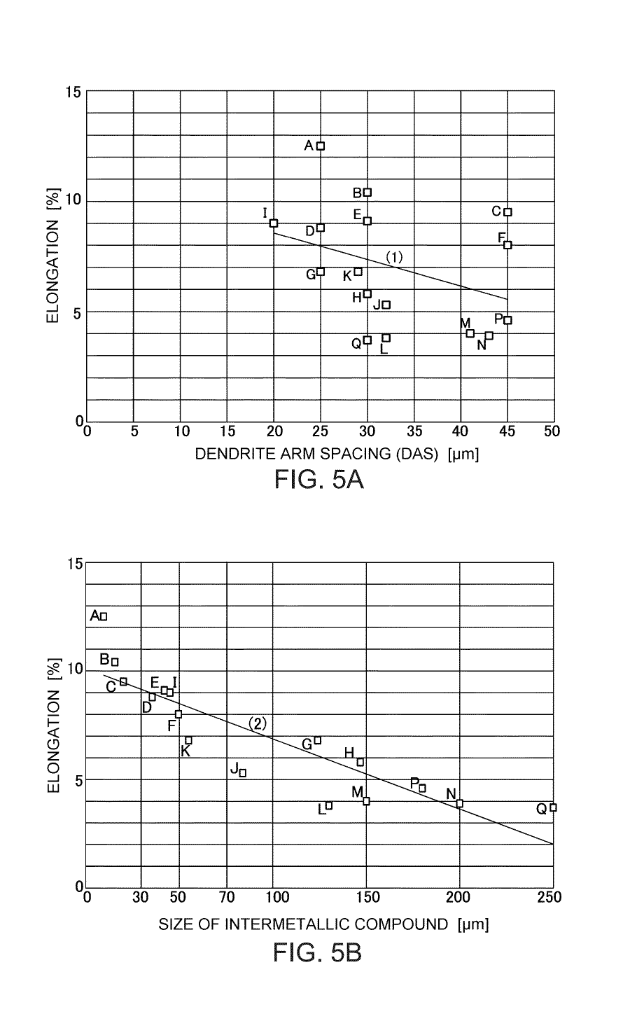

With respect to the respective examples, the specification, the result of measurement of physical properties and the evaluation are shown in Table 1. Symbols A to Q (except for O) in Table 1 correspond to plots shown in FIG. 5 to FIG. 7 which are explained later.

TABLE 1

| | | | | | | | | | | | | result of measurement | | |
|---|---|---|---|---|---|---|---|---|---|---|---|---|---|---|
| | | | | | | | | | | | | | size of | |
| | | | composition (%) | | | | | | | | | DAS | intermetallic | Elongation |
| No. | Plot | | Si | Mg | Cu | Mn | Fe | Ti | Zn | Sr | Al | [μm] | compound[μm] | [%] |
| 1 | A | example 1 | 7.1 | 0.29 | 0.23 | 0.15 | 0.1 | 0.1 | 0.32 | 0.01 | balance | 25 | 9.6 | 12.5 |
| 2 | B | example 2 | 7.3 | 0.28 | 0.24 | 0.18 | 0.1 | 0.1 | 0.31 | 0.01 | ↑ | 30 | 15.6 | 10.4 |
| 3 | C | exampe 3 | 7.1 | 0.29 | 0.22 | 0.15 | 0.1 | 0.1 | 0.31 | 0.01 | ↑ | 45 | 20.2 | 9.5 |
| 4 | D | example 4 | 7.2 | 0.29 | 0.25 | 0.15 | 0.28 | 0.1 | 0.33 | 0.01 | ↑ | 25 | 35.5 | 8.8 |
| 5 | E | example 5 | 7.1 | 0.29 | 0.24 | 0.17 | 0.28 | 0.1 | 0.29 | 0.01 | ↑ | 30 | 42 | 9.1 |
| 6 | F | example 6 | 7.1 | 0.28 | 0.23 | 0.19 | 0.28 | 0.1 | 0.30 | 0.01 | ↑ | 45 | 49.6 | 8 |
| 7 | G | example 7 | 7.3 | 0.29 | 0.25 | 0.2 | 0.51 | 0.1 | 0.29 | 0.01 | ↑ | 25 | 124 | 6.8 |
| 8 | H | example 8 | 7.2 | 0.28 | 0.24 | 0.2 | 0.51 | 0.1 | 0.30 | 0.01 | ↑ | 30 | 146.8 | 5.8 |
| 9 | I | example 9 | 7.5 | 0.29 | 0.24 | 0.15 | 0.51 | 0.1 | 0.28 | 0.01 | ↑ | 20 | 45 | 9 |
| 10 | J | example 10 | 7.2 | 0.28 | 0.23 | 0.17 | 0.51 | 0.1 | 0.27 | 0.01 | ↑ | 32 | 84 | 5.3 |
| 11 | K | example 11 | 7.1 | 0.29 | 0.24 | 0.15 | 0.51 | 0.1 | 0.31 | 0.01 | ↑ | 29 | 55 | 6.8 |
| 12 | L | comparison | 7.2 | 0.29 | 0.25 | 0.18 | 0.65 | 0.1 | 0.28 | 0.01 | ↑ | 32 | 130 | 3.8 |
| | | example 1 | | | | | | | | | | | | |
| 13 | M | comparison | 7.1 | 0.29 | 0.25 | 0.25 | 0.65 | 0.1 | 0.27 | 0.01 | ↑ | 41 | 150 | 4 |
| | | example 2 | | | | | | | | | | | | |
| 14 | N | comparison | 7.4 | 0.29 | 0.25 | 0.25 | 0.65 | 0.1 | 0.26 | 0.01 | ↑ | 43 | 200 | 3.9 |
| | | example 3 | | | | | | | | | | | | |
| 15 | P | comparison | 7.2 | 0.29 | 0.25 | 0.3 | 0.51 | 0.1 | 0.30 | 0.01 | ↑ | 45 | 180 | 4.6 |
| | | example 4 | | | | | | | | | | | | |
| 16 | Q | comparison | 7.1 | 0.28 | 0.25 | 0.3 | 0.51 | 0.1 | 0.29 | 0.01 | ↑ | 30 | 250 | 3.7 |
| | | example 5 | | | | | | | | | | | | |

In the example 1, molten metal having the chemical composition that comprises 7.1% of Si, 0.29% of Mg, 0.23% of Cu, 0.15% of Mn, 0.1% of Fe, 0.1% of Ti, 0.32% of Zn, and 0.01 of Sr with the balance being Al and unavoidable impurities is prepared by adding various elements to an aluminum raw material by melting an aluminum alloy.

Next, a wheel for a motorcycle is manufactured by casting the above-mentioned molten metal by gravity die casting using the die for casting 20. As explained in conjunction with FIG. 4, specimens are prepared from this wheel for a motorcycle, and mechanical characteristics of these tensile test specimens are measured using a tensile strength tester. Dendrite arm spacing (DAS) is also measured based on an SEM photograph of the specimen.

Here, the casting, the preparation of specimens and the measurement of specimens are performed in the same manner with respect to the examples 2 to 11 and the comparison examples 1 to 5, which are explained hereinafter.

In the example 1, a wheel for a motorcycle is eventually obtained where dendrite arm spacing is 25 μm, a size of an intermetallic compound is 9.6 μm, and the elongation is 12.5%.

In the example 2, a weight ratio of a chemical composition of molten metal is set such that the chemical composition comprises 7.3% of Si, 0.28% of Mg, 0.24% of Cu, 0.18% of Mn, 0.1% of Fe, 0.1% of Ti, 0.31% of Zn, and 0.01 of Sr with the balance being Al and unavoidable impurities.

In the example 2, a wheel for a motorcycle is eventually obtained where dendrite arm spacing is 30 μm, a size of an intermetallic compound is 15.6 μm, and the elongation is 10.4%.

In the example 3, a weight ratio of a chemical composition of molten metal is set such that the chemical composition comprises 7.1% of Si, 0.29% of Mg, 0.22% of Cu, 0.15% of Mn, 0.1% of Fe, 0.1% of Ti, 0.31% of Zn, and 0.01 of Sr with the balance being Al and unavoidable impurities.

In the example 3, a wheel for a motorcycle is eventually obtained where dendrite arm spacing is 45 μm, a size of an intermetallic compound is 20.2 μm, and the elongation is 9.5%.

In the example 4, a weight ratio of a chemical composition of molten metal is set such that the chemical composition comprises 7.2% of Si, 0.29% of Mg, 0.25% of Cu, 0.15% of Mn, 0.28% of Fe, 0.1% of Ti, 0.33% of Zn, and 0.01 of Sr with the balance being Al and unavoidable impurities.

In the example 4, a wheel for a motorcycle is eventually obtained where dendrite arm spacing is 25 μm, a size of an intermetallic compound is 35.5 μm, and the elongation is 8.8%.

In the example 5, a weight ratio of a chemical composition of molten metal is set such that the chemical composition comprises 7.1% of Si, 0.29% of Mg, 0.24% of Cu, 0.17% of Mn, 0.28% of Fe, 0.1% of Ti, 0.29% of Zn, and 0.01 of Sr with the balance being Al and unavoidable impurities.

In the example 5, a wheel for a motorcycle is eventually obtained where dendrite arm spacing is 30 μm, a size of an intermetallic compound is 42 μm, and the elongation is 9.1%.

In the example 6, a weight ratio of a chemical composition of molten metal is set such that the chemical composition comprises 7.1% of Si, 0.28% of Mg, 0.23% of Cu, 0.19% of Mn, 0.28% of Fe, 0.1% of Ti, 0.30% of Zn, and 0.01 of Sr with the balance being Al and unavoidable impurities.

In the example 6, a wheel for a motorcycle is eventually obtained where dendrite arm spacing is 45 μm, a size of an intermetallic compound is 49.6 μm, and the elongation is 8%.

In the example 7, a weight ratio of a chemical composition of molten metal is set such that the chemical composition comprises 7.3% of Si, 0.29% of Mg, 0.25% of Cu, 0.2% of Mn, 0.51% of Fe, 0.1% of Ti, 0.29% of Zn, and 0.01 of Sr with the balance being Al and unavoidable impurities.

In the example 7, a wheel for a motorcycle is eventually obtained where dendrite arm spacing is 25 μm, a size of an intermetallic compound is 124 μm, and the elongation is 6.8%.

In the example 8, a weight ratio of a chemical composition of molten metal is set such that the chemical composition comprises 7.2% of Si, 0.28% of Mg, 0.24% of Cu, 0.2% of Mn, 0.51% of Fe, 0.1% of Ti, 0.30% of Zn, and 0.01 of Sr with the balance being Al and unavoidable impurities.

In the example 8, a wheel for a motorcycle is eventually obtained where dendrite arm spacing is 30 μm, a size of an intermetallic compound is 146.8 μm, and the elongation is 5.8%.

In the example 9, a weight ratio of a chemical composition of molten metal is set such that the chemical composition comprises 7.5% of Si, 0.29% of Mg, 0.24% of Cu, 0.15% of Mn, 0.51% of Fe, 0.1% of Ti, 0.28% of Zn, and 0.01 of Sr with the balance being Al and unavoidable impurities.

In the example 9, a wheel for a motorcycle is eventually obtained where dendrite arm spacing is 20 μm, a size of an intermetallic compound is 45 m, and the elongation is 9%.

In the example 10, a weight ratio of a chemical composition of molten metal is set such that the chemical composition comprises 7.2% of Si, 0.28% of Mg, 0.23% of Cu, 0.17% of Mn, 0.51% of Fe, 0.1% of Ti, 0.27% of Zn, and 0.01 of Sr with the balance being Al and unavoidable impurities.

In the example 10, a wheel for a motorcycle is eventually obtained where dendrite arm spacing is 32 μm, a size of an intermetallic compound is 84 μm, and the elongation is 5.3%.

In the example 11, a weight ratio of a chemical composition of molten metal is set such that the chemical composition comprises 7.1% of Si, 0.29% of Mg, 0.24% of Cu, 0.15% of Mn, 0.51% of Fe, 0.1% of Ti, 0.31% of Zn, and 0.01 of Sr with the balance being Al and unavoidable impurities.

In the example 11, a wheel for a motorcycle is eventually obtained where dendrite arm spacing is 29 μm, a size of an intermetallic compound is 55 μm, and the elongation is 6.8%.

In the comparison example 1, a weight ratio of a chemical composition of molten metal is set such that the chemical composition comprises 7.2% of Si, 0.29% of Mg, 0.25% of Cu, 0.18% of Mn, 0.65% of Fe, 0.1% of Ti, 0.28% of Zn, and 0.01 of Sr with the balance being Al and unavoidable impurities.

In the comparison example 1, a wheel for a motorcycle is eventually obtained where dendrite arm spacing is 32 μm, a size of an intermetallic compound is 130 μm, and the elongation is 3.8%.

In the comparison example 2, a weight ratio of a chemical composition of molten metal is set such that the chemical composition comprises 7.1% of Si, 0.29% of Mg, 0.25% of Cu, 0.25% of Mn, 0.65% of Fe, 0.1% of Ti, 0.27% of Zn, and 0.01 of Sr with the balance being Al and unavoidable impurities.

In the comparison example 2, a wheel for a motorcycle is eventually obtained where dendrite arm spacing is 41 μm, a size of an intermetallic compound is 150 μm, and the elongation is 4%.

In the comparison example 3, a weight ratio of a chemical composition of molten metal is set such that the chemical composition comprises 7.4% of Si, 0.29% of Mg, 0.25% of Cu, 0.25% of Mn, 0.65% of Fe, 0.1% of Ti, 0.26% of Zn, and 0.01 of Sr with the balance being Al and unavoidable impurities.

In the comparison example 3, a wheel for a motorcycle is eventually obtained where dendrite arm spacing is 43 μm, a size of an intermetallic compound is 200 μm, and the elongation is 3.9%.

In the comparison example 4, a weight ratio of a chemical composition of molten metal is set such that the chemical composition comprises 7.2% of Si, 0.29% of Mg, 0.25% of Cu, 0.3% of Mn, 0.51% of Fe, 0.1% of Ti, 0.30% of Zn, and 0.01 of Sr with the balance being Al and unavoidable impurities.

In the comparison example 4, a wheel for a motorcycle is eventually obtained where dendrite arm spacing is 45 μm, a size of an intermetallic compound is 180 μm, and the elongation is 4.6%.

In the comparison example 5, a weight ratio of a chemical composition of molten metal is set such that the chemical composition comprises 7.1% of Si, 0.28% of Mg, 0.25% of Cu, 0.3% of Mn, 0.51% of Fe, 0.1% of Ti, 0.29% of Zn, and 0.01 of Sr with the balance being Al and unavoidable impurities.

In the comparison example 5, a wheel for a motorcycle is eventually obtained where dendrite arm spacing is 30 μm, a size of an intermetallic compound is 250 μm, and the elongation is 3.7%.

FIG. 5A to FIG. 7 are charts showing characteristics of aluminum alloys for a vehicle of the examples and comparison examples.

FIG. 5A shows an example of correlation between dendrite arm spacing and toughness with respect to the examples 1 to 11 and the comparison examples 1 to 5. In the drawing, symbol (1) indicates a linear approximation curve obtained based on results of the examples 1 to 11 and the comparison examples 1 to 5.

As shown in FIG. 5A, the correlation where the smaller dendrite arm spacing, the larger the elongation becomes is recognized. Based on the approximation curve (1), it becomes apparent that when dendrite arm spacing is 45 μm or less, the elongation becomes at least 5% or more. Accordingly, a preferred value of the dendrite arm spacing is 45 μm or less, a more preferred value of the dendrite arm spacing is 40 μm or less, and the further more preferred value of the dendrite arm spacing is 35 μm or less. It becomes apparent that when the dendrite arm spacing is set to 25 μm or less, the most preferred value is obtained with respect to the elongation.

FIG. 5B shows an example of correlation between a size of an intermetallic compound and toughness with respect to the examples 1 to 11 and the comparison examples 1 to 5. In the drawing, symbol (2) indicates a linear approximation curve obtained based on results of the examples 1 to 11 and the comparison examples 1 to 5.

As shown in FIG. 5B, the correlation where the smaller the size of an intermetallic compound, the larger the elongation becomes is recognized. It becomes apparent that when the size of an intermetallic compound is 150 μm or less, the elongation becomes at least 5% or more. Based on the linear approximation curve (2), a preferred value of the size of an intermetallic compound is 150 μm or less, a more preferred value of the size of an intermetallic compound is 100 μm or less, and a further more preferred value of the size of an intermetallic compound is 70 μm or less. It becomes apparent that when the size of an intermetallic compound is set to 30 μm or less, the most preferred value is obtained with respect to the elongation.

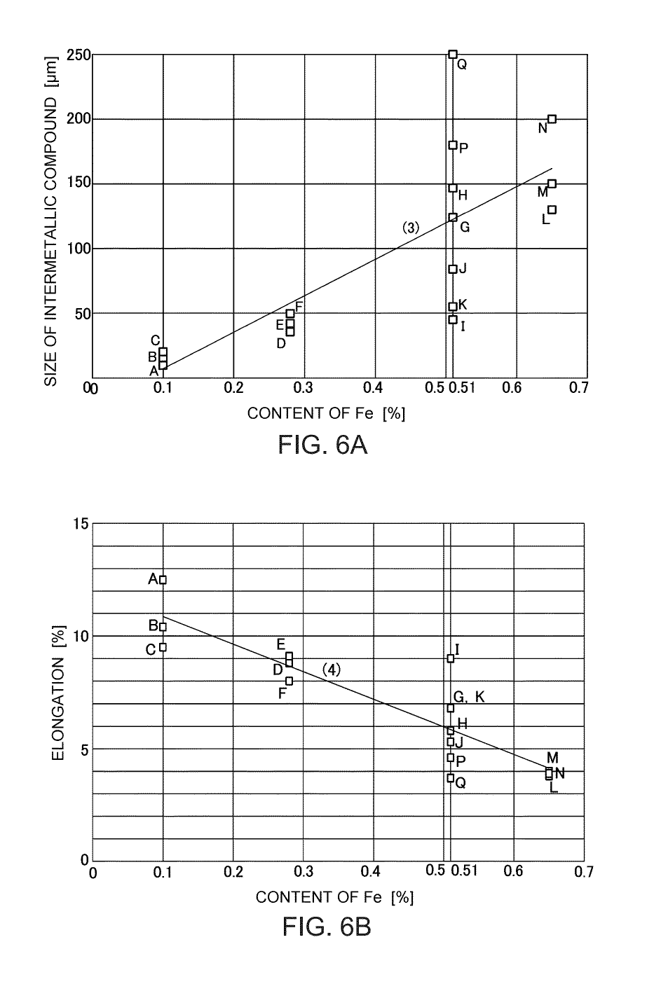

FIG. 6A is a chart showing an example of correlation between the content of Fe and a size of an intermetallic compound with respect to the examples 1 to 11 and the comparison examples 1 to 5. In the drawing, symbol (3) indicates a linear approximation curve obtained based on results of the examples 1 to 11 and the comparison examples 1 to 5.

As shown in FIG. 6A, the correlation where the larger the content of Fe, the larger the size of the intermetallic compound becomes is recognized. As described above, it is apparent that the smaller the size of an intermetallic compound, the more excellent elongation the specimen exhibits. Based on the linear approximation curve (3), it becomes apparent that when the content of Fe is 0.51% or less, the size of the intermetallic compound can be suppressed to 150 μm or less. To take into account a significant figure, it is safe to say that the content of Fe is preferably set to 0.5% or less (including 0.51%). In other words, it becomes apparent that even when a raw material containing Fe such as a reproduced ingot aluminum material is used as an aluminum raw material, provided that content of Fe is 0.5% or less, it is possible to acquire the elongation suitable for a vehicle part.

FIG. 6B is a chart showing an example of correlation between the content of Fe and the toughness with respect to the examples 1 to 11 and the comparison examples 1 to 5. In the drawing, symbol (4) indicates a linear approximation curve obtained based on results of the examples 1 to 11 and the comparison examples 1 to 5.

As explained in conjunction with FIG. 6A, it becomes apparent that the larger the content of Fe, the larger the size of an intermetallic compound becomes leading to the lowering of the elongation. Based on the approximation curve (4) shown in FIG. 6B, it becomes apparent that when the content of Fe is set to 0.51% or less, a preferred value of at least 5% or more can be obtained with respect to the elongation. To take into account a significant figure, it is safe to say that the content of Fe is preferably set to 0.5% or less (including 0.51%). In other words, it becomes apparent that even when a raw material containing Fe such as a reproduced ingot aluminum material is used as an aluminum raw material, provided that the content of Fe is 0.5% or less, it is possible to acquire the elongation suitable for a vehicle part.

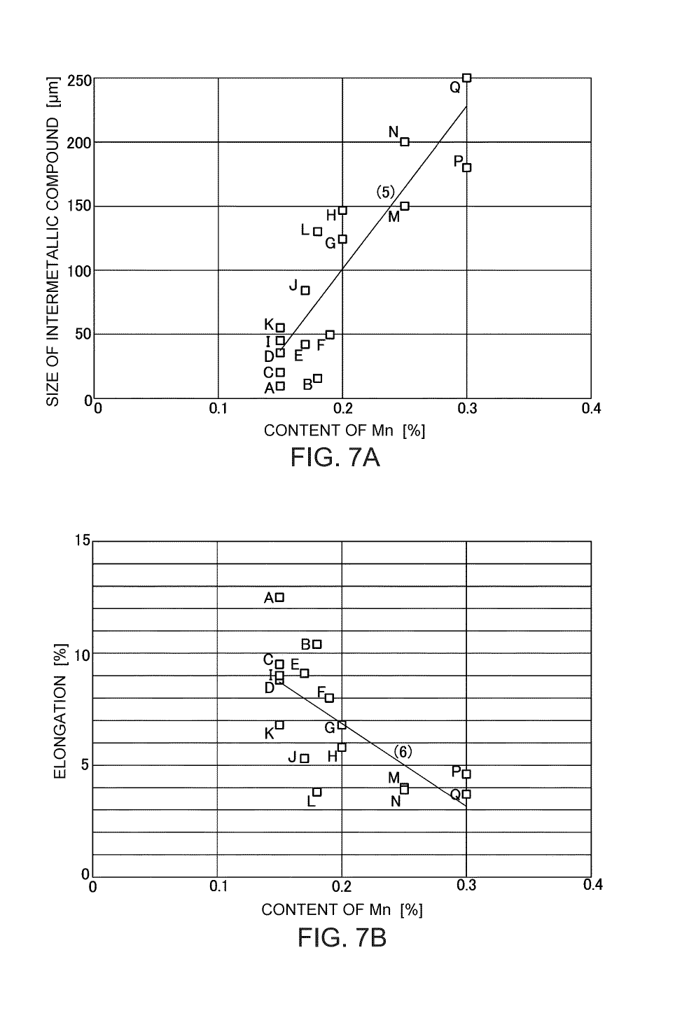

FIG. 7A is a chart showing an example of correlation between the content of Mn and a size of an intermetallic compound with respect to the examples 1 to 11 and the comparison examples 1 to 5. In the drawing, symbol (5) indicates a linear approximation curve obtained based on results of the examples 1 to 11 and the comparison examples 1 to 5.

As shown in FIG. 7A, the correlation where the larger the content of Mn, the larger the size of an intermetallic compound becomes is recognized. As described above, it is apparent that the smaller the size of an intermetallic compound, the more excellent elongation the specimen exhibits. Based on the approximation curve (5), it becomes apparent that when the content of Mn is 0.2% or less, the size of an intermetallic compound can be suppressed to 100 μm or less so that it is preferable to set the content of Mn to 0.2% or less.

FIG. 7B is a chart showing an example of correlation between the content of Mn and toughness with respect to the examples 1 to 11 and the comparison examples 1 to 5. In the drawing, symbol (6) indicates a linear approximation curve obtained based on results of the examples 1 to 11 and the comparison examples 1 to 5.

As explained in conjunction with FIG. 7A, it becomes apparent that the larger the content of Mn, the larger the size of an intermetallic compound becomes leading to the lowering of the elongation. Based on the examples 7, 8 (plots G, H) and the approximation curve (6) in FIG. 7B, it becomes apparent that when the content of Mn is set to 0.2% or less, a preferred value of at least 5% or more can be obtained with respect to the elongation. In other words, it becomes apparent that even when a raw material containing Mn such as a reproduced ingot aluminum material is used as an aluminum raw material, provided that the content of Mn is set to 0.2% or less, it is possible to acquire the elongation suitable for a vehicle part.

Further, as shown in Table 1, in all examples 1 to 11 where the elongation of 5% or more is acquired as a result, the content of Cu is 0.25% or less. Accordingly, even when an aluminum alloy containing Cu which is manufactured using a reproduced ingot aluminum material as a raw material is used, by setting the content of Cu to 0.4% or less, most preferably 0.25% or less, the aluminum alloy can acquire toughness suitable for an aluminum alloy for a vehicle.

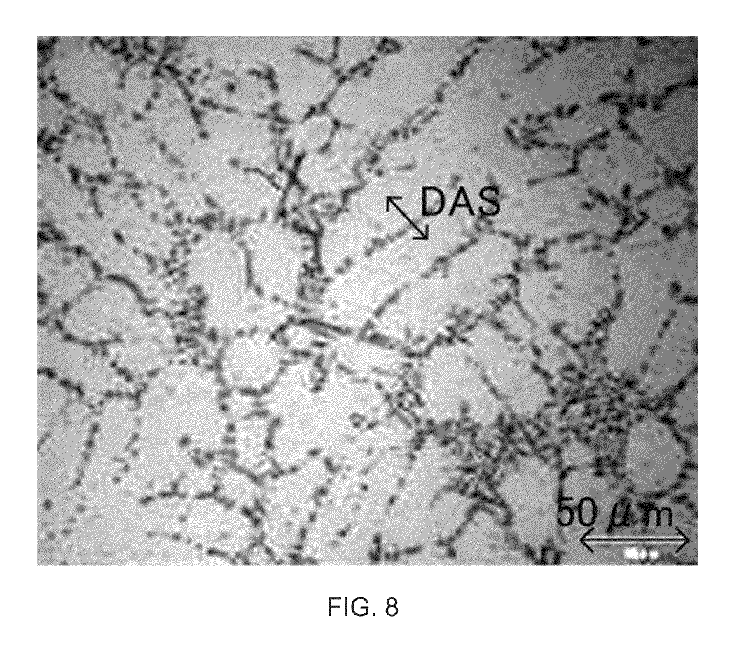

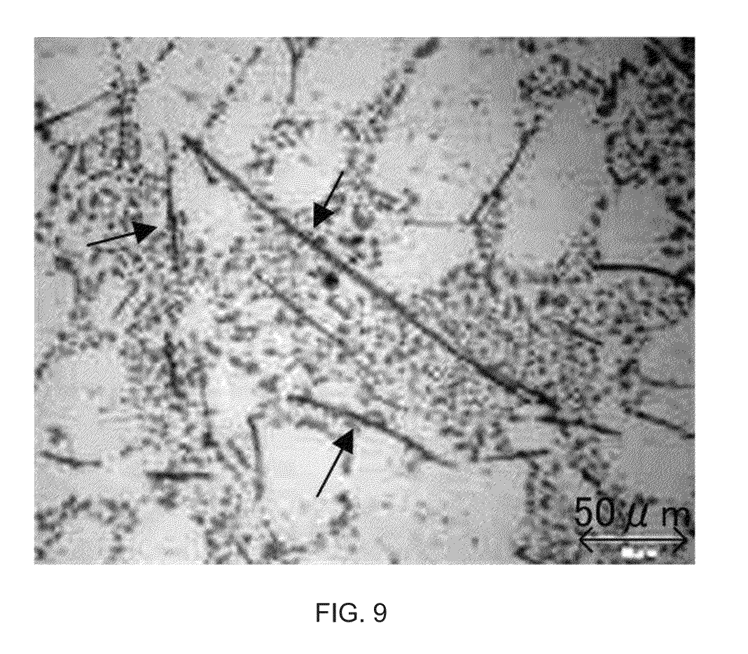

FIG. 8 shows an SEM photograph of the example 9 as a preferable example of an aluminum alloy for a vehicle. Further, FIG. 9 is an SEM photograph of the comparison example 4.

As shown in FIG. 8, dendrite arm spacing (DAS in the drawing) of the cast product of the example 9 is apparently small compared to a scale of 50 μm shown in the photograph. Further, any intermetallic compound present between primary-crystal α-Al crystals has a lump shape, and a size of the intermetallic compound is small compared to the scale of 50 μm shown in the photograph. In the example 9, the cast product that exhibits the elongation of 9% is obtained.

To the contrary, as indicated by an arrow in FIG. 9, the cast product of the comparison example 4 contains needle-shaped crystals made of an intermetallic compound where a size of the crystal is large compared to a scale of 50 μm shown in the photograph. The elongation of the cast product of the comparison example 4 is 4.6% and is lower than 5% that is used as the reference in determining the above-mentioned preferred value.

The aluminum alloy for a vehicle according to the invention exhibits the elongation suitable for a vehicle part. Accordingly, by casting the aluminum alloy by gravity die casting using various kinds of dies, the aluminum alloy can be used for parts of vehicles including a motorcycle. As described previously, the aluminum alloy is particularly suitable for manufacturing suspension parts of a vehicle including a wheel for a motorcycle. That is, although the explanation has been made by taking the wheel for a motorcycle as the particularly preferable example, the aluminum alloy for a vehicle can be used for manufacturing a part such as a swing arm, a bracket (bridge) that holds a front fork.

### DESCRIPTION OF REFERENCE NUMERALS AND SIGNS

10: wheel for a motorcycle
11: hub
15: spoke
17: rim
20, 40: die for casting
21, 41: upper die
23, 43: lower die
25, 45: slide die
27: core
31: pouring port
37: discharge port
39a, 39b, 39c: cooling liquid flow passage
49a, 49b, 49c: molding surface

What is claimed is:

1. An aluminum alloy for a vehicle having the composition comprising, by weight %, 0.5% or less of Fe, 0.2% or less of Mn, Si, and Cu with the balance being Al and unavoidable impurities, wherein
dendrite arm spacing is 45 μm or less, and a size of an intermetallic compound is 150 μm or less.

2. The aluminum alloy for a vehicle according to claim 1, wherein the dendrite arm spacing is 40 μm or less and the size of the intermetallic compound is 100 μm or less.

3. The aluminum alloy for a vehicle according to claim 2, wherein the dendrite arm spacing is 35 μm or less and the size of the intermetallic compound is 70 μm or less.

4. The aluminum alloy for a vehicle according to claim 3, wherein the dendrite arm spacing is 25 μm or less and the size of the intermetallic compound is 30 μm or less.

5. A wheel for a motorcycle which is formed using the aluminum alloy for a vehicle having the composition comprising, by weight %, 0.5% or less of Fe, 0.2% or less of Mn, Si, and Cu with the balance being Al and unavoidable impurities, wherein
dendrite arm spacing is 45 μm or less, and a size of an intermetallic compound is 150 μm or less.

6. The wheel for a motorcycle according to claim 5, wherein a thickness of a rim portion is set to 20 mm or less.

7. The wheel for a motorcycle according to claim 5, wherein the wheel for a motorcycle is manufactured by gravity die casting using a die that includes an upper die, a lower die and a slide die having a rim portion, and forms a cooling liquid flow passage for accelerating a cooling rate in a portion of at least any one of the upper die, the lower die or the slide die where the rim portion is formed.

8. The wheel for a motorcycle according to claim 5, wherein the wheel for a motorcycle is manufactured by gravity die casting using a die that includes an upper die, a lower die and a slide die having a rim portion, and has a molding surface thereof for forming the rim portion formed on any one of the upper die, the lower die and the slide die using a beryllium copper alloy.

9. The wheel for a motorcycle according to claim 6, wherein the wheel for a motorcycle is manufactured by gravity die casting using a die that includes an upper die, a lower die and a slide die having a rim portion, and forms a cooling liquid flow passage for accelerating a cooling rate in a portion of at least any one of the upper die, the lower die or the slide die where the rim portion is formed.

10. The wheel for a motorcycle according to claim 6, wherein the wheel for a motorcycle is manufactured by gravity die casting using a die that includes an upper die, a lower die and a slide die having a rim portion, and has a molding surface thereof for forming the rim portion formed on any one of the upper die, the lower die and the slide die using a beryllium copper alloy.
